(19) United States
(12) Patent Application Publication
(10) Pub. No.: US 2008/0126044 A1
(43) Pub. Date: May 29, 2008

(54) MODEL SIMPLIFICATION METHOD FOR USE IN MODEL-BASED DEVELOPMENT

(75) Inventor: Takanori DEGAKI, Numazu-shi (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 11/946,353

(22) Filed: Nov. 28, 2007

(30) Foreign Application Priority Data
Nov. 28, 2006 (JP) 2006-320215

(51) Int. Cl. G06G 7/70

(52) U.S. Cl. 703/8

(57) ABSTRACT

Determination values are obtained by calculating values for each partial model of a complete model base at each unit time, and by integrating absolute values of change amounts of the values and absolute value of change amount of a product of at least two values, according to the engine acceleration pattern. A set of the determination values including a specific determination value of a specific partial model having the most influence on a specific value calculated using the model base is selected, wherein the specific determination value is the largest among the determination values of all the partial models. A higher priority is assigned to a partial model with a higher determination value. The model base is determined by omitting a partial model from the complete model base in order of ascending priority until a desired processing load of calculating the specific value is obtained.

### INCORPORATION BY REFERENCE

The disclosure of Japanese Patent Application No. 2006-320215 filed on Nov. 28, 2006 including the specification, drawings and abstract is incorporated herein by reference in its entirety.

### BACKGROUND OF THE INVENTION

1. Field of the Invention

The present invention relates to a model simplification method for use in model-based development.

2. Description of the Related Art

In recent years, proposals have been made to model an engine intake system for implementation in a vehicle ECU and to calculate using a model base, for example, an intake air amount during a transient period, which cannot be detected accurately with an airflow meter. In order to accurately calculate the intake air amount, it is ideal to implement a model base obtained by modeling the entire engine intake system in the ECU. In practice, however, it is difficult to implement such a model base because of the enormous processing load on the ECU.

Therefore, it is necessary to simplify the model base that is implemented in the ECU by disregarding certain partial models that comprise the model base of the engine intake system. By estimating the calculation load using such a simplified model base in advance, it is possible to select a model base that allows actual calculation by the ECU (see Japanese Patent Application Publication No. 2005-78243 (JP-A-2005-78243), for example). Other similar techniques are described in Japanese Patent Application Publication No. 2004-340022 (JP-A-2004-340022) and Japanese Patent Application Publication No. 2005-202925 (JP-A-2005-202925).

In simplifying a model base, it is important to determine the partial models of the engine intake system that may be omitted. While omission of an arbitrarily selected partial model may reduce the processing load, it is likely to introduce significant errors in the calculation. It should be understood that this problem is not restricted to model-based development of engine intake systems, but is also raised in model-based development of other systems such as engine drive systems.

### SUMMARY OF THE INVENTION

The present invention provides a model simplification method for use in model-based development to simplify a model base that is implemented in a vehicle ECU without significantly decreasing the calculation accuracy.

A first aspect of the present invention provides a model simplification method to determine a model base that may be implemented in an ECU, the method including; preparing an complete model base by modeling respective parts of an entire system of the model base; setting a plurality of integrals as determination values for each corresponding partial model, the plurality of integrals being obtained by calculating a plurality of values for each corresponding partial model at each unit time according to a predetermined engine acceleration pattern, and by integrating absolute values of change amounts of the plurality of values and an absolute value of a change amount of a product of at least two of the plurality of values according to the engine acceleration pattern; selecting a set of the determination values that include a specific determination value of a specific partial model having the most influence on a specific value that is calculated using the model base, wherein the specific determination value is the largest among the determination values of all the partial models; assigning a higher priority to those partial models that have a higher determination value; and determining the model base by omitting partial models from the entire model base in order of ascending priority until a processing load of the specific value is reduced to a desired value.

A second aspect of the present invention provides the model simplification method in accordance with the above first aspect, in which: the model base is an engine intake system, and the specific value is a flow rate of intake air that is supplied into a cylinder; a throttle partial model is specified as the specific partial model having the most influence on the flow rate of intake air that is supplied into the cylinder; the determination values include an integral obtained by calculating an intake air flow rate and an intake pressure for the respective partial models of the entire model base at each unit time while an opening degree of a throttle valve is gradually increased according to the engine acceleration pattern, and by integrating the absolute value of the change amount of the product of the intake air flow rate and the intake pressure according to the engine acceleration pattern; and a set of the determination values that include a specific determination value of the throttle partial model is selected, wherein the specific determination value is the largest among the determination values of all the partial models.

A third aspect of the present invention provides the model simplification method in accordance with the above first aspect, in which: the model base is an engine drive system, and the specific value is torque that is transmitted to a tire; a transmission partial model is specified as the specific partial model having the most influence on the torque that is transmitted to the tire; the determination values include an integral obtained by calculating torque for the respective partial models of the entire model base at each unit time while torque generated by an engine is gradually increased according to the engine acceleration pattern, and by integrating the absolute value of the change amount of torque according to the engine acceleration pattern; and a set of the determination values that include a specific determination value of the transmission partial model is selected, wherein the specific determination value is the largest among the determination values of all the partial models.

A fourth aspect of the present invention provides the model simplification method in accordance with the above first aspect, in which: the model base is an engine drive system, and the specific value is a torsion amount of the engine drive system; a drive shaft partial model is specified as the specific partial model having the most influence on the torsion amount; the determination values include an integral obtained by calculating torque and an angular speed for the respective partial models of the entire model base at each unit time while torque generated by an engine is gradually increased according to the engine acceleration pattern, and by integrating the absolute value of the change amount of the product of the torque and the angular speed according to the engine acceleration pattern, and a set of the determination values that include a specific determination value of the drive shaft partial model is selected, wherein the specific determination value is the largest among the determination values of all the partial models.

A fifth aspect of the present invention provides a model simplification method to determine a model base that is implemented in an ECU, the method including: preparing an complete model base by modeling respective parts of an entire system of the model base; setting a plurality of integrals as determination values for each corresponding partial model, the plurality of integrals being obtained by calculating a plurality of values for each partial model at each unit time according to a predetermined engine acceleration pattern, and by integrating absolute values of change amounts of the plurality of values and an absolute value of a change amount of a product of at least two of the plurality of values according to the engine acceleration pattern; selecting a set of the determination values as first determination values that include a first specific determination value of a first specific partial model having the most influence on a first specific value, which is intended to be calculated using the Model base, wherein the first specific determination value is the largest among the first determination values of all the partial models; selecting another set of the determination values as second determination values that include a second specific determination value of a second specific partial model having the most influence on a second specific value, which is intended to be calculated using the model base, wherein the second specific determination value is the largest among the second determination values of all the partial models; calculating a first ratio of the first determination value for each corresponding partial model to the sum of the first determination values of all the partial models, and calculating a second ratio of the second determination value for each corresponding partial model to the sum of the second determination values of all the partial models; setting the larger of one the first ratio and the second ratio as a determination ratio for each corresponding partial model; assigning a higher priority to a partial model with a higher determination ratio; and determining the model base by omitting a partial model from the complete model base in order of ascending priority until a processing load of the first specific value and the second specific value is reduced to an appropriate value.

A sixth aspect of the present invention provides a calculation method using a model base, including: when a current processing capacity of the ECU is reduced during calculation of the specific value using the model base determined by the model simplification method for use in model-based development according to the above first to fourth aspects and implemented in the ECU, reducing the processing load of the specific value to or below the current processing capacity of the ECU by omitting partial models from the model base in order of ascending priority.

A seventh aspect of the present invention provides a calculation method using a model base, including: when a current processing capacity of the ECU is reduced during calculation of the first specific value or the second specific value using the model base determined by the model simplification method for use in model-based development according to the above fifth aspect and implemented in the ECU, reducing the processing load of the first specific value or the second specific value to or below the current processing capacity of the ECU by omitting partial models from the model base in order of increasing first ratio during the calculation of the first specific value, and by omitting partial models from the model base in order of increasing second ratio when calculating the second specific value.

According to the above first aspect of the model simplification method, a plurality of integrals are obtained by calculating a plurality of values for each partial model of a complete model base at each unit time according to a predetermined engine acceleration pattern, and by integrating the absolute values of the change amounts of the plurality of values and the absolute value of the change amount of a product of at least two of the plurality of values according to the engine acceleration pattern. The plurality of integrals are defined as determination values for each partial model. A set of the determination values that include a specific determination value of a specific partial model having the greatest influence on a specific value, which is intended to be calculated using the model base, wherein the specific determination value is the largest among the determination values of all the partial models. A higher priority is assigned to a partial model with a higher determination value. Because a partial model that is assigned a low priority does not significantly influence the calculation of the specific value, omission of such a partial model would not introduce significant error into the calculation of the specific value. Therefore, the model base is determined by omitting a partial model from the complete model base in order of ascending priority until the processing load of the specific value is reduced to a desired value.

According to the above second aspect providing the model simplification method according to the above first aspect, the model base is an engine intake system, and the specific value is a flow rate of intake air that is supplied into a cylinder A throttle partial model is specified as the specific partial model having the most influence on the flow rate of intake air that is supplied into the cylinder. The determination values includes an integral obtained by calculating an intake air flow rate and an intake pressure for the respective partial models of the complete model base at each unit time while an opening degree of a throttle valve is gradually increased according to the engine acceleration pattern, and by integrating the absolute value of the change amount of the product of the intake air flow rate and the intake pressure according to the engine acceleration pattern. A set of the determination values that include a specific determination value of the throttle partial model is selected, wherein the specific determination value is the largest among the determination values of all the partial models. A higher priority is assigned to a partial model with a higher determination value. Therefore, the intake port partial model and so forth, for example, are assigned lower priorities and thus omitted to determine the model base.

According to the above third aspect providing the model simplification method according to the above first aspect, the model base is an engine drive system, and the specific value is torque that is transmitted to a tire. A transmission partial model is specified as the specific partial model having the most influence on the torque that is transmitted to the tire. The determination values includes an integral obtained by calculating torque for the respective partial models of the complete model base at each unit time while torque generated by an engine is gradually increased according to the engine acceleration pattern, and by integrating the absolute value of the change amount of torque according to the engine acceleration pattern. A set of the determination values that include a specific determination value of the transmission partial model is selected, wherein the specific determination value is the largest among the determination values of all the partial models. A higher priority is assigned to a partial model with a higher determination value. Therefore, the drive shaft partial model and so forth, for example, are assigned lower priorities and thus omitted to determine the model base.

According to the above fourth aspect providing the model simplification method according to the above first aspect, the model base is an engine drive system, and the specific value is a torsion amount of the engine drive system. A drive shaft partial model is specified as the specific partial model having the most influence on the torsion amount. The determination values includes an integral obtained by calculating torque and an angular speed for the respective partial models of the complete model base at each unit time while torque generated by an engine is gradually increased according to the engine acceleration pattern, and by integrating the absolute value of the change amount of the product of the torque and the angular speed according to the engine acceleration pattern. A set of the determination values that include a specific determination value of the drive shaft partial model is selected, wherein the specific determination value is the largest among the determination values of all the partial models. A higher priority is assigned to a partial model with a higher determination value. Therefore, the transmission partial model and so forth, for example, are assigned low priorities and thus omitted to determine the model base.

According to the above fifth aspect providing a model simplification method a plurality of integrals are obtained by calculating a plurality of values for each partial model of a complete model base at each unit time according to a predetermined engine acceleration pattern, and by integrating the absolute values of the change amounts of the plurality of values and the absolute value of the change amount of a product of at least two of the plurality of values according to the engine acceleration pattern. The plurality of integrals are defined as determination values for each corresponding partial model. A set of the determination values is selected as first determination values that include a first specific determination value of a first specific partial model having the most influence on a first specific value, which is intended to be calculated using the model base, wherein the first specific determination value is the largest among the first determination values of all the partial models. Another set of the determination values is selected as second determination values that include a second specific determination value of a second specific partial model having the most influence on a second specific value, which is intended to be calculated using the model base, wherein the second specific determination value is the largest among the second determination values of all the partial models. Assigning priorities according to the first determination value may result in a low priority being assigned to a partial model that has a significant influence on the calculation of the second specific value, and thereby result in the omission of such a partial model. Conversely, by assigning priorities according to the second determination value may result in a low priority being assigned to a partial model that has a significant influence on the calculation of the first specific value, and thereby result in the omission of such a partial model. Therefore, a first ratio of the first determination value for each partial model to a sum of the first determination values of all the partial models is calculated, and a second ratio of the second determination value for the respective partial models to a sum of the second determination values of all the partial models is calculated. The larger of either the first ratio or the second ratio is defined as a determination ratio for each partial model. A higher priority is assigned to a partial model with a higher determination ratio. Because a partial model that is assigned a low priority does not significantly influence the calculation of either the first specific value or the second specific value, omission of such a partial model would not introduce significant errors in the calculation of either of the first specific value and the second specific value. Therefore, the model base is determined by omitting a partial model from the complete model base in order of ascending priority until the processing load of the first specific value and the second specific value is reduced to a desired value.

According to the calculation method using a model base according to the above sixth aspect, if the instantaneous processing capacity of the ECU is reduced during calculation of the specific value using the model base determined by the model simplification method according to the above first to fourth aspects and implemented in the ECU, the processing load of the specific value is reduced to or below the current processing capacity of the ECU or less by omitting a partial model from the model base in order of ascending priority.

According to the calculation method using a model base according to the above seventh aspect, when a current processing capacity of the ECU is reduced during calculation of the first specific value or the second specific value using the model base determined by the model simplification method according to the above fifth aspect and implemented in the ECU, the processing load of the first specific value or the second specific value is reduced to or below the current processing capacity of the ECU by, during the calculation of the first specific value omitting a partial model from the model base in order of ascending first ratio, which is equivalent to the priority in this calculation and by, during the calculation of the second specific value, omitting a partial model from the model base in order of ascending second ratio, which is equivalent to the priority in this calculation.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a schematic diagram of an engine intake system that is simplified by a model simplification method in accordance with the present invention;

FIG. 2 is a graph showing changes in power input to and output from an air filter partial model;

FIG. 3 is a graph showing changes in power input to and output from a throttle partial model;

FIG. 4 is a graph showing changes in power input to and output from a surge tank partial model;

FIG. 5 is a graph showing changes in power input to and output from an intake port partial model;

FIG. 6 is a schematic diagram of an engine drive system that is simplified by a model simplification method in accordance with the present invention;

FIG. 7 is a graph showing changes in torque input to and output from a clutch partial model;

FIG. 8 is a graph showing changes in torque input to and output from a transmission partial model;

FIG. 9 is a graph showing changes in torque input to and output from a propeller shaft partial model;

FIG. 10 is a map of engine-generated torque based on the engine speed and the throttle valve opening degree;

FIG. 11 is a graph showing the relationship between the slip ratio and the friction coefficient of a tire; and

FIG. 12 is a flowchart to perform calculation after omitting a partial model from a model base implemented in an ECU according to the processing capacity of the ECU.

### DETAILED DESCRIPTION OF THE PREFERRED EMBODIMENTS

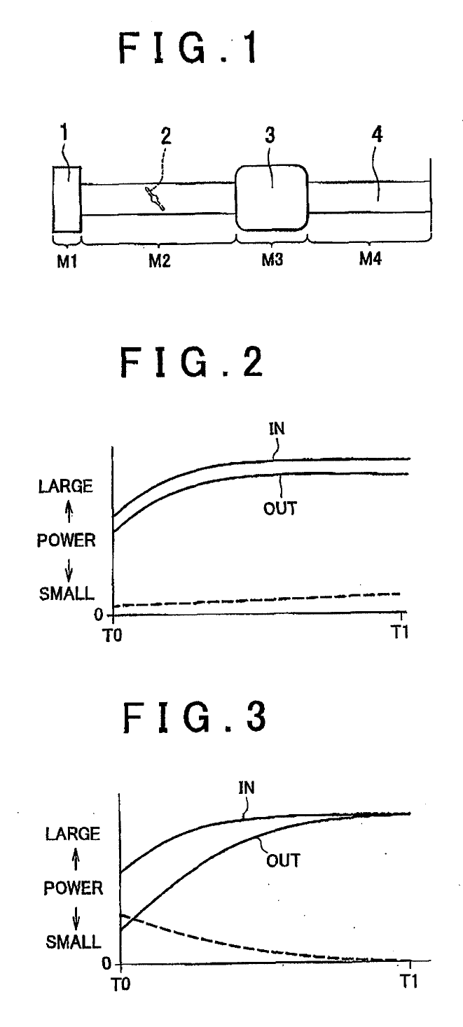

FIG. 1 is a schematic diagram showing an engine intake system. FIG. 1 shows an air filter 1, a throttle valve 2, a surge tank 3, and an intake port 4. In order to calculate the flow rate of intake air flowing into a cylinder in such an engine intake system, for example, using a model simplification method for use in model-based development in accordance this embodiment, first, a complete model base is prepared by modeling respective parts of the entire engine intake system, before determining a model base for implementation in a vehicle ECU. Using such a complete model base, it is possible to accurately calculate the flow rate of the intake air flowing into the cylinder, even when the engine is in a transient state. However, it is difficult for the vehicle ECU to calculate the intake air flow rate using the complete model base because of the enormous processing load. For implementation in the vehicle ECU, it is necessary to simplify the complete model base by ignoring (or discarding) a portion of the model.

The complete model base is made up, for example, of an air filter partial model M1, a throttle partial model M2, a surge tank partial model M3, and an intake port partial model M4. It should be understood that a partial model may further be subdivided for modeling. For example, the throttle partial model M2 may be divided into the portion where the throttle valve 2 is positioned and the portions of the intake passage upstream and downstream of the throttle valve 2, where each portion is modeled separately, and the intake port partial model M4 also may further be divided for modeling.

The air filter partial model M1 may be represented, for example, by the following equation (1):

m=C*(Pᵢₙ−Pₒᵤₜ) (1)

where m represents the flow rate of intake air flowing through the air filter partial model M1, and the flow rate of intake air flowing into the air filter partial model M1 is considered to be equal to the flow rate of intake air flowing out of the air filter partial model M1. C represents the flow rate coefficient of the air filter, Pᵢₙ represents the pressure of intake air flowing into the air filter partial model M1, and Pₒᵤₜ represents the pressure of intake air flowing out of the air filter partial model M1.

The throttle partial model M2 is represented, for example, by the following equation (2):

$$m = Ct ( TA ) At ( TA ) {P}_{in} \sqrt{\frac{k + 1}{2 kRT}} \sqrt{{( \frac{k}{k + 1} )}^{2} - {( \frac{{P}_{out}}{{P}_{in}} - \frac{1}{k + 1} )}^{2}} \qquad ( 2 )$$

where m represents the flow rate of intake air flowing through the throttle valve 2, and the flow rate of intake air flowing into the throttle partial model M2 is considered to be equal to the flow rate of intake air flowing out of the throttle partial model M2. Ct represents the flow rate coefficient of the throttle valve 2 that varies with the throttle valve opening degree TA; At represents the opening area of the throttle valve 2 that varies with the throttle valve opening degree TA; Pᵢₙ represents the pressure of intake air flowing into the throttle partial model M2; Pout represents the pressure of intake air flowing out of the throttle partial model M2; k represents the specific heat ratio, and R represents the gas constant. T represents the intake temperature, and the temperature of intake air flowing into the throttle partial model M2 is considered to be equal to the temperature of intake air flowing out of the throttle partial model M2.

The surge tank partial model M3 may be represented, for example, by the following equations (3) and (4):

$$\begin{matrix}\frac{d ( P / T )}{d t} = \frac{R}{V} ( {m}_{in} - {m}_{out} ) & ( 3 ) \\ \frac{d P}{d t} = k \frac{R}{V} ( {m}_{in} {T}_{in} - {m}_{out} {T}_{out} ) & ( 4 )\end{matrix}$$

where mᵢₙ represents the flow rate of intake air flowing into the surge tank partial model M3, and mₒᵤₜ represents the flow rate of intake air flowing out of the surge tank partial model M3. P represents the pressure of intake air in the surge tank 3, and the pressure of intake air flowing into the surge tank partial model M3 is considered to be equal to the pressure of intake air flowing out of the surge tank partial model M3. V represents the volume of the surge tank 3; k represents the specific heat ratio; R represents the gas constant; Tᵢₙ represents the temperature of intake air flowing into the surge tank partial model M3; and Tₒᵤₜ represents the temperature of intake air flowing out of the surge tank partial model M3.

The intake port partial model M4 may be represented, for example, by the equations (3) and (4) given above. In this case, mᵢₙ represents the flow rate of intake air flowing into the intake port partial model M4; mᵢₙ represents the flow rate of intake air flowing out of the intake port partial model M4; P represents the pressure in the intake port 4, and the pressure of intake air flowing into the intake port partial model M4 is considered to be equal to the pressure of intake air flowing, out of the intake port partial model M4. V represents the volume of the intake port 4; k represents the specific heat ratio; R represents the gas constant; Tᵢₙ represents the temperature of intake air flowing into the intake port partial model M4; and Tₒᵤₜ represents the temperature of intake air flowing out of the intake port partial model M4.

In the complete model base of the engine intake system such as described above, the flow rate mᵢₙ, the pressure Pᵢₙ, and the temperature Tᵢₙ of intake air flowing into each partial model, and the flow rate mₒᵤₜ, the pressure Pₒᵤₜ, and the temperature Tₒᵤₜ of intake air flowing out of each partial model, are calculated at each predetermined tiring based on the pressure P1 and the temperature T1 in a cylinder downstream of the intake port partial model M4, the pressure P2 and the temperature T2 of the atmosphere upstream of the air filter partial model M1, and the throttle valve opening degree TA on the assumption that the flow rate mᵢₙ, the pressure Pᵢₙ, and the temperature Tᵢₙ of intake air flowing into a partial model are equal to the flow rate mₒᵤₜ, the pressure Pₒᵤₜ, and the temperature Tₒᵤₜ of intake air flowing out of a partial model immediately upstream thereof. Thus, in the complete model base, the flow rate of air flowing out of the intake port partial model M4 positioned furthest downstream is the flow rate of intake air flowing into the cylinder at each predetermined timing. It should be understood that all of the intake air flow rate, the intake pressure, and the intake temperature may not necessarily be changed in each partial model, depending on the equation used to represent the model. For example, for a partial model where the intake temperature is defined not to be changed, Tᵢₙ and Tₒᵤₜ are calculated as the same value of the temperature Tₒᵤₜ of intake air flowing out of a partial model upstream thereof.

It is important to determine which partial models to omit from the complete model base for the purpose of simplification. Omission of an arbitrary partial model may lead not only to a reduction of the processing load but also to a significant decrease of the calculation accuracy. In view of the above, in the simplification method in accordance with this embodiment of the present invention, a plurality of integrals are obtained by calculating a plurality of values for the respective partial models of the complete model base at each unit time according to a predetermined engine acceleration pattern, and by integrating the absolute values of the change amounts of the plurality of values and the absolute value of the change amount of a product of at least two of the plurality of values according to the engine acceleration pattern. The plurality of integrals are set as determination values for each partial model. A set of the determination values that include a specific determination value of a specific partial model having the most influence on a specific value that is calculated using the model base is selected, wherein the specific determination value is the largest among the determination values of all the partial models. A higher priority is assigned to a partial model with a higher determination value. Because a partial model that has a low priority does not significantly influence the calculation of the specific value, omission of such a partial model would not significantly decrease the calculation accuracy of the specific value. Therefore, the model base is determined by omitting partial models from the complete model base in order of ascending priority until the processing load of the specific value is reduced to a desired value.

Specifically, the opening degree of the throttle valve is gradually increased according to a predetermined engine acceleration pattern, for example from a fully closed state to a fully open state, during a period from timing T0 to timing T1. A plurality of values are calculated for the respective partial models at each predetermined timing during this period (during which the pressure (negative pressure) and the temperature in the cylinder are considered to be constant with an intake valve kept open). The absolute values of the change amounts of the plurality of values, and of a product of at least two of these values, namely the absolute value of the change amount of intake air flow rate Δm(mₒᵤₜ−mᵢₙ), the absolute value of the change amount of intake pressure ΔP(Pₒᵤₜ−Pᵢₙ), the absolute value of the change amount of intake temperature ΔT(Tₒᵤₜ−Tᵢₙ) and, for example, the absolute value of the change amount of power ΔmP(mPₒᵤₜ−mPᵢₙ), are integrated from time T0 to time T1 to obtain integrals ΣΔm, ΣΔP, ΣΔT, and ΣΔmP. The integrals are defined as determination values that are used to determine the appropriate partial model to omit.

Because this model base is used to calculate the flow rate of intake air that is supplied into the cylinder as the specific value, it would not be appropriate to omit the throttle partial model M2. Therefore, a set of the determination values that include a specific determination value of the throttle partial model M2 is selected, wherein the specific determination value is the largest among the determination values of all the partial models. For example, the integral ΣΔmP of the absolute value of the change amount of power is selected from the determination values.

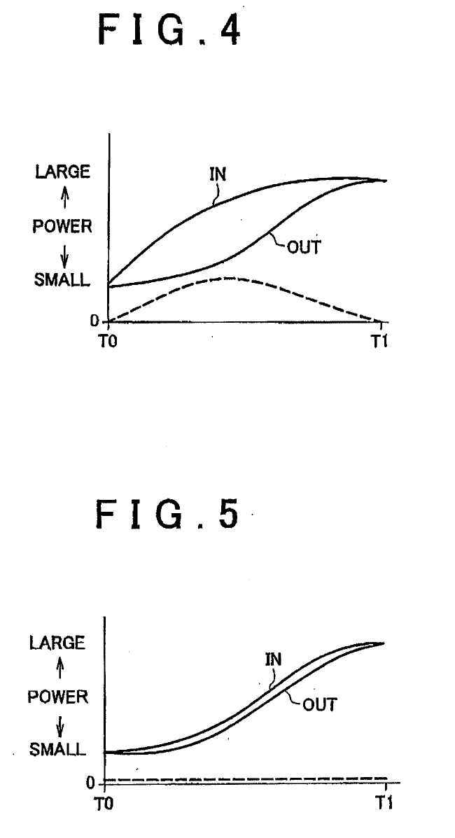

FIG. 2 shows the air filter partial model M1, where the solid line IN shows changes in the input power, the solid line OUT shows changes in the output power, and the dashed line shows changes in the absolute value of the change amount of power input to and output from the air filter partial model M1. Likewise, FIG. 3 shows the throttle partial model M2, FIG. 4 shows the surge tank partial model M3, and FIG. 5 shows the intake port partial model M4. Consequently, the integral of the absolute value of the change amount of power for the period from timing T0 to timing T1 is the largest with the throttle partial model M2, sequentially followed by, for example, the surge tank partial model M3, the air filter partial model M1, and the intake port partial model M4. A partial model having a larger determination value is assigned a higher priority.

As a result of assigning the highest priority to the throttle partial model M2, the intake port partial model M4, which has the lowest priority is first omitted from the complete model base. This is because a partial model assigned a low priority does not significantly influence the calculation of the intake air flow rate. If necessary, the air filter partial model M1 with the second lowest priority may be the next partial model to be omitted.

In this way, if the surge tank partial model M3 is omitted, for example, the output value of the throttle partial model M2 is used as the input value of the intake port partial model M4, which thereby reduces the processing load of calculating the intake air flow rate. The model base for implementation in the vehicle ECU is determined by omitting partial models in order of ascending priority until the processing load is reduced to the appropriate level for implementation in the ECU.

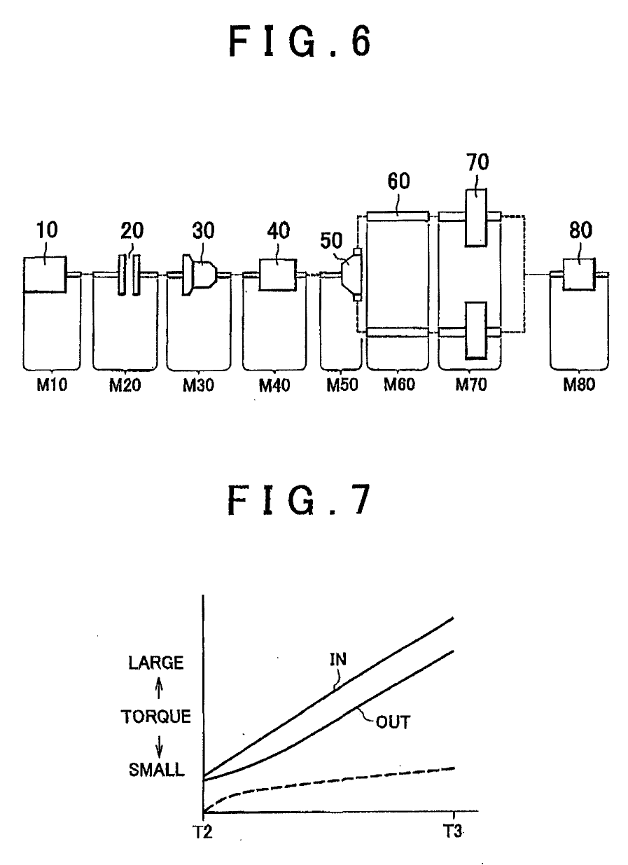

A simplification method to determine a model base for implementation in a vehicle ECU to calculate the torque that is transmitted to a tire part model, in order to calculate the vehicle speed or the vehicle acceleration in an engine drive system, will be described below. FIG. 6 is a schematic diagram showing an engine dive system. FIG. 6 shows an engine 10, a clutch 20, a transmission 30, a propeller shaft 40, a differential device 50, a drive shaft 60, a tire 70, and a vehicle 80. As described above, first, a complete model base is prepared by modeling respective parts of the entire engine drive system.

The complete model base may be made up, for example, of a clutch partial model M20, a transmission partial model M30, a propeller shaft partial model M40, a differential partial model M50 and a drive shaft partial model M60. As described below, an engine partial model M10 is a source that generates torque and angular speed, and a tire partial model M70 and a vehicle partial model M80 are used to calculate the vehicle speed and the vehicle acceleration from the torque and the angular speed that is input to the tire partial model M70. Therefore, these are not included in the complete model base.

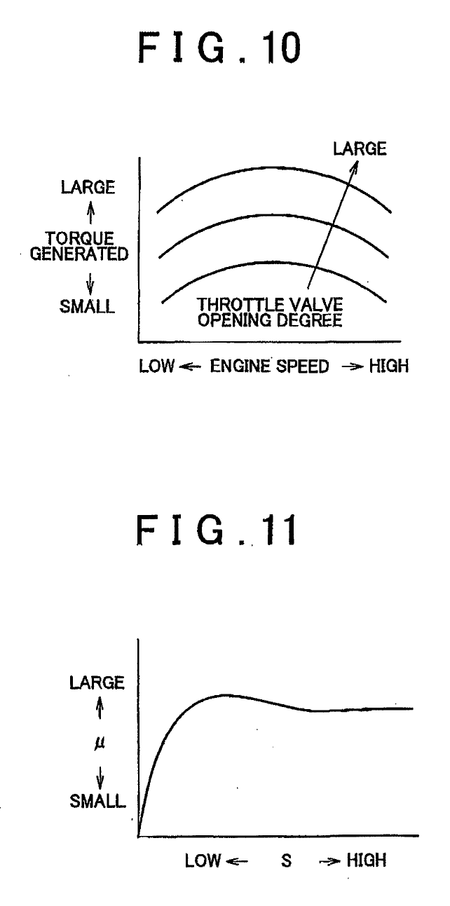

The engine partial model M10 is represented, for example, by a map of torque that is generated based on the engine speed and the throttle valve opening degree shown in FIG. 10.

The clutch partial model M20 is represented, for example, by the following equations (5) and (6):

$$\begin{matrix}{I}_{1} \frac{d {ω}_{in}}{d t} = {T}_{in} - K ( {θ}_{in} - {θ}_{out} ) & ( 5 ) \\ {I}_{2} \frac{d {ω}_{in}}{d t} = {T}_{out} - K ( {θ}_{in} - {θ}_{out} ) & ( 6 )\end{matrix}$$

where I₁ represents the inertia moment of the clutch 20 on the engine side, 12 represents the inertia moment of the clutch 20 on the transmission side, ωᵢₙ represents the input angular speed, ωₒᵤₜ represents the output angular speed, Tᵢₙ represents the input torque, Tout represents the output torque, θᵢₙ represents the input rotational angle, θₒᵤₜ represents the output rotational angle, and K represents the spring constant of the clutch 20.

The transmission partial model M30 is represented, for example, by the following equations (7) and (8):

Tₒᵤₜ=N*Tᵢₙ (7)

?ᵢₙ=N*?ₒᵤₜ (8)

where N represents the gear ratio, ωᵢₙ represents the input angular speed, ωₒᵤₜ represents the output angular speed, Tᵢₙ represents the input torque, and Tₒᵤₜ represents the output torque.

The propeller shaft partial model M40 is represented, for example, by the following equations (9), (10), and (11):

$$\begin{matrix}I \frac{d ω}{d t} = {T}_{in} - K ( {θ}_{in} - {θ}_{out} ) & ( 9 ) \\ {T}_{out} = K ( {θ}_{in} - {θ}_{out} ) & ( 10 ) \\ ω = \frac{d}{d t} ( {θ}_{in} + {θ}_{out} ) & ( 11 )\end{matrix}$$

where I represents the inertia moment of the propeller shaft 40, ω represents the angular speed, and the input and output angular speeds are considered to be equal to each other. Tᵢₙ represents the input torque, Tₒᵤₜ represents the output torque, θᵢₙ represents the input rotational angle, θₒᵤₜ represents the output rotational angle, and K represents the rigidity of the propeller shaft 40.

The differential partial model M50 is represented, for example, by the following equations (12), (13), and (14):

ωᵢₙ=(ω_{Rout}+ω_{Lout})N/2 (12)

T_{Rout}=T_{Lout} (13)

−TᵢₙN=T_{Rout}+T_{Lout} (14)

where ωᵢₙ represents the input angular speed, ω_{Rout} represents the output angular speed on the right side, ω_{Lout} represents the output angular speed on the left side, Tᵢₙ represents the input torque, T_{Rout} represents the output torque on the right side, T_{Lout} represents the output torque on the left side, and N represents the differential gear ratio.

The drive shaft partial model M60 may be represented, for example, by the equations (9), (10), and (11) given above. Here, I represents the inertia moment of the drive shaft 60, ω represents the angular speed, and the input and output angular speeds are considered to be equal to each other. Tᵢₙ represents the input torque, Tₒᵤₜ represents the output torque, θᵢₙ represents the input rotational angle, θₒᵤₜ represents the output rotational angle, and K represents the rigidity of the drive shaft 60.

The tire partial model M70 is represented, for example, by the following equations (15) and (16):

$$\begin{matrix}I \frac{d ω}{d t} = T - RN μ ( S ) & ( 15 ) \\ S = ( ω R - v ) / v & ( 16 )\end{matrix}$$

where I represents the inertia moment of the tire, ω represents the angular speed of the tire, T represents the torque that is transmitted to the tire, N represents the load that is carried by the tire, μ represents the friction coefficient of the tire which changes as shown in FIG. 11 according to the slip ratio s, R represents the radius of the tire, and v represents the vehicle speed.

The vehicle partial model M80 is represented, for example, by the following equation (17):

$$m \frac{d v}{d t} = {N}_{R} μ ( {S}_{R} ) + {N}_{L} μ ( {S}_{L} ) - F ( v ) \qquad ( 17 )$$

where m represents the vehicle weight, v represents the vehicle speed, N_{R} represents the load that is carried by the right tire, N_{L} represents the load that is carried by the left tire, μ represents the friction coefficient of the tire which changes as shown in FIG. 11 according to the slip ratio s, S_{R} represents the slip ratio of the right tire, S_{L} represents the slip ratio of the left tire, and F represents the rolling resistance as a function of the vehicle speed v.

In the complete model base of the engine drive system described above, the torque Tᵢₙ and the angular speed ωᵢₙ input to each partial model, and the torque Tₒᵤₜ and the angular speed ωₒᵤₜ output from each partial model, are calculated at each timing based on the torque and the angular speed output from the engine partial model M10 on the assumption that the torque Tᵢₙ and the angular speed than input to each partial model are equal to the torque Tₒᵤₜ and the angular speed ωₒᵤₜ output from a partial model immediately upstream thereof. The torque Tₒᵤₜ and the angular speed ωₒᵤₜ output from the drive shaft partial model M60 are transmitted to the tire partial model M70, and the vehicle speed and the vehicle acceleration at each predetermined timing are calculated in the tire partial model M70 and the vehicle partial model M80.

In an engine drive system, the torque generated by the engine is gradually increased (at the same time, the angular speed of a crankshaft, which serves as the output angular speed, is changed) according to a predetermined engine acceleration pattern, preferably from a minimum torque to a maximum torque, during a period from timing T2 to timing T3. A plurality of values are calculated for each partial model at each predetermined timing during this period. The absolute values of the change amounts of the plurality of values, and of a product of at least two of these values, namely the absolute value of the change amount of torque ΔT(Tₒᵤₜ−Tᵢₙ), the absolute value of the change amount of angular speed Δω(ωₒᵤₜ−ωᵢₙ), and the absolute value of the change amount of power ΔTω(Tωₒᵤₜ−Tωᵢₙ), are integrated from timing T2 to timing T3 to obtain integrals ΣΔT, ΣΔω, and ΣΔTω. The integrals are defined as determination values for use to determine a partial model to be omitted.

Because this model base is used to calculate the torque T that is transmitted to the tire partial model M70 (and at the same time, the angular speed ω that is transmitted to the tire partial model M70) as the specific value in order to calculate the vehicle speed and the vehicle acceleration, it would not be appropriate to omit the transmission partial model M30 having the most influence, of the respective partial models, on the calculation of the torque. Therefore, a set of the determination values that include a specific determination value of the transmission partial model M30 is selected, wherein the specific determination value is the largest among the determination values of all the partial models. For example, the integral ΣΔT of the absolute value of the change amount of torque is selected from the determination values.

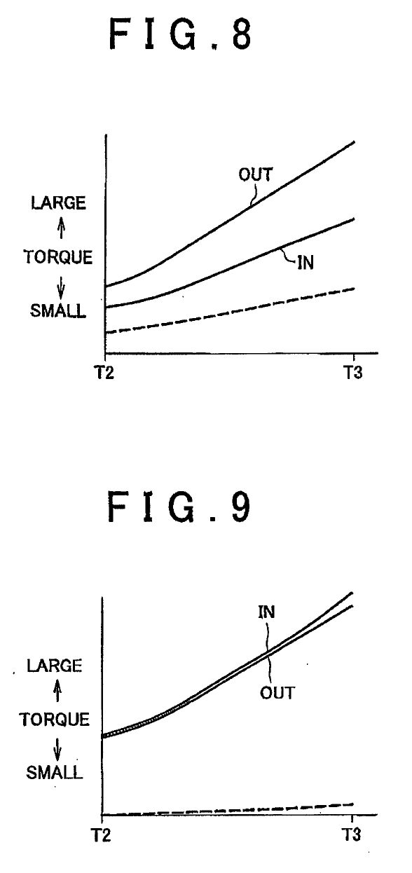

FIG. 7 shows the clutch partial model M20, where the solid line IN shows changes in the input torque, the solid line OUT shows changes in the output torque, and the dashed line shows changes in the absolute value of the change amount of torque input to and output from the clutch partial model M20. Likewise, FIG. 8 shows the transmission partial model M30, and FIG. 9 shows the propeller shaft partial model M40. Changes in the absolute value of the change amount of the input and output torques are calculated in the same way also for the differential partial model M50 and the drive shaft partial model M60.

As a result, the integral of the absolute value of the change amount of torque for the period from time T2 to time T3 is the largest with the transmission partial model M30, sequentially followed by, for example, the clutch partial model M20, the differential partial model M50, the propeller shaft partial model M40, and the drive shaft partial model M60. A partial model having a larger determination value is assigned a higher priority.

As a result of assigning the highest priority to the transmission partial model M30, the drive shaft partial model M60 with the lowest priority is first omitted from the complete model base. This is because a partial model assigned a low priority does not significantly influence the calculation of the torque. If appropriate, the propeller shaft partial model M40, which has the next higher priority, may also be omitted. In this way, the model base for implementation in the vehicle ECU is determined by omitting a partial model in order of ascending priority until the processing load of the torque is reduced to a desired value for implementation in the ECU.

If the model base is used to calculate the torsional vibration of a vehicle drive train, it is necessary to calculate the torsion amount of the drive train that is transmitted to the tire partial model M70 as the specific value. In this case, it would not be appropriate to omit the drive shaft partial model M60, which has the greatest influence on the calculation of the torsion amount of all the respective partial models. Therefore, a set of the determination values that include a specific determination value of the drive shaft partial model M60 is selected, wherein the specific determination value is the largest among the determination values of all the partial models. For example, the integral of the absolute value of the change amount of the product of the torque and the angular speed, namely that of power ΣΔTω, is selected from the determination values.

As a result, the integral of the absolute value of the change amount of power for the period from timing T2 to timing T3 is the largest with the drive shaft partial model M60, sequentially followed by, for example, the clutch partial model M20, the differential partial model M50, the propeller shaft partial model M40, and the transmission partial model M30. Partial models that have a larger determination value is assigned a higher priority.

As a result of assigning the highest priority to the drive shaft partial model M60, the transmission partial model M30, which has the lowest priority, is first omitted from the complete model base. This is because a partial model assigned a low priority does not significantly influence the calculation of the torsion amount. If necessary, the propeller shaft partial model M40, which has the second-lowest priority, is then omitted. In this way, the model base for implementation in the vehicle ECU is determined by omitting partial models in order of ascending priority until the processing load of the torsion amount is reduced to a desired value for implementation in the ECU.

In a model base of an engine drive system, it may occasionally be desirable to calculate both the vehicle speed and the vehicle acceleration and the torsional vibration of the engine drive system as a first specific value and a second specific value. In this case, selecting the integral of the absolute value of the change amount of torque from the determination values to omit the drive shaft partial model M60 would not result in accurate calculation of the torsional vibration of the engine drive system, while selecting the integral of the absolute value of the change amount of power from the determination values to omit the transmission partial model M30 would not result in accurate calculation of the vehicle speed and the vehicle acceleration.

Therefore, in this case, the integral values of the absolute values of the change amounts of torque are selected as first determination values, while the integral values of the absolute values of the change amounts of power are selected as second determination values. A first ratio of the first determination value for each partial model to the sum of the first determination values of all the partial models is calculated, while a second ratio of the second determination value for each partial model to the sum of the second determination values of all the partial models is calculated. The larger of the first ratio and the second ratio is defined as a determination ratio for each partial model. A partial model with a higher determination ratio is assigned a higher priority.

Because a partial model assigned a low priority does not significantly influence the calculation of either the torque transmitted to the tire or the torsional vibration, omission of such a partial model would not introduce significant error into the calculation of the torque transmitted to the tire or the torsional vibration. Therefore, the model base is determined by omitting partial models from the entire model base in order of ascending priority until the processing load of the torque transmitted to the tire and the torsional vibration is reduced to a desired value.

For example, the determination ratio is the largest with the drive shaft partial model M60 (0%, 45%), sequentially followed by the transmission partial model M30 (40%, 0%), the clutch partial model M20 (25%, 30%), the differential partial model M50 (20%, 15%), and the propeller shaft partial model M40 (15%, 10%). Here, the ratios in the parentheses indicate (first ratio, second ratio). The model base for implementation in the ECU is determined by omitting a partial model in the reverse order.

In this way, the model base with which the desired processing load is achieved is implemented in the vehicle ECU. In the vehicle ECU, the calculation using the model base may be temporarily difficult when, for example, an important determination such as the detection of a misfire is required and the processing capacity of the ECU is reduced accordingly. In this case, it is preferable to reduce the processing load by further omitting a partial model from the model base that has been obtained by omitting a partial model and implemented in the ECU.

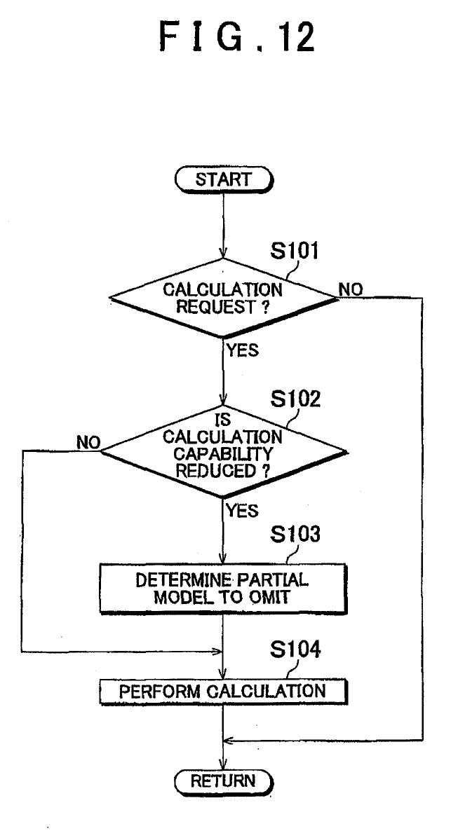

FIG. 12 is a flowchart showing the calculation performed after omitting a partial model from the model base implemented in the ECU according to the processing capacity of the ECU. First, in step 110, it is determined whether or not there is any request to calculate a specific value. If the determination is negative, the process is terminated. On the other hand, if the determination in step 101 is positive, it is determined in step 102 whether or not the current processing capacity of the ECU is reduced by another calculation. If the determination is negative, the process proceeds to step 104, where the specific value is calculated using the model base implemented in the ECU.

In contrast, if the determination in step 102 is positive, the calculation using the model base currently implemented in the ECU would be difficult, and therefore the partial model to be omitted is determined in step 103. Because the partial models have been assigned priorities in the determination of the model base implemented in the ECU as described above, the partial models are omitted based on an order of ascending priority. Once the processing load of the specific value is reduced to or below the current processing capacity of the ECU by omitting one or more partial models as described above, the specific value is calculated in step 104.

When the processing capacity of the ECU is temporarily reduced, such as when calculating the first specific value or the second specific value using the model base, it is not desirable to omit a partial model from the model base implemented in the ECU using the same priorities as those assigned to omit a partial model from the complete model base. This is because such priorities have been assigned to calculate both the first specific value and the second specific value.

If the first specific value is to be calculated, it is preferable to reduce the processing load of the first specific value to or below the current processing capacity of the ECU by omitting a partial model from the model base in order of ascending first ratio, which is equivalent to the priority in this calculation. Meanwhile, if the second specific value is to be calculated, it is preferable to reduce the processing load of the second specific value to or below the current processing capacity of the ECU by omitting a partial model from the model base in order of ascending second ratio, which is equivalent to the priority in this calculation.

What is claimed is:

1. A model simplification method for use in model-based development to determine a model base for implementation in an ECU, the method comprising:
preparing a complete model base by modeling respective parts of an entire system of the model base;
setting a plurality of integrals as determination values for each corresponding partial model, the plurality of integrals being obtained by calculating a plurality of values for each partial model at each unit time according to a predetermined engine acceleration pattern, and by integrating absolute values of change amounts of the plurality of values and an absolute value of a change amount of a product of at least two of the plurality of values according to the engine acceleration pattern;
selecting a set of the determination values that include a specific determination value of a specific partial model having the most influence on a specific value that is calculated using the model base, wherein the specific determination value is the largest among the determination values of all the partial models;
assigning a higher priority to a partial model with a higher determination value; and
determining the model base by omitting a partial model from the entire model base in order of ascending priority until a processing load of the specific value is reduced to a desired value.

2. The model simplification method for use in model-based development according to claim 1, wherein
the model base is an engine intake system, and the specific value is a flow rate of intake air that is supplied into a cylinder;
a throttle partial model is specified as the specific partial model having the most influence on the flow rate of intake air that is supplied into the cylinder;
the determination values include an integral obtained by calculating an intake air flow rate and an intake pressure for each partial model of the complete model base at each unit time while an opening degree of a throttle valve is gradually increased according to the engine acceleration pattern, and by integrating the absolute value of the change amount of the product of the intake air flow rate and the intake pressure according to the engine acceleration pattern; and
a set of the determination values that include a specific determination value of the throttle partial model is selected, wherein the specific determination value is the largest among the determination values of all the partial models.

3. The model simplification method for use in model-based development according to claim 1, wherein
the model base is an engine drive system, and the specific value is torque that is transmitted to a tire;
a transmission partial model is specified as the specific partial model having the most influence on the torque that is transmitted to the tire;
the determination values include an integral obtained by calculating torque for each partial model of the complete model base at each unit time while torque generated by an engine is Gradually increased according to the engine acceleration pattern, and by integrating the absolute value of the change amount of torque according to the engine acceleration pattern; and
a set of the determination values that include a specific determination value of the transmission partial model is selected, wherein the specific determination value is the largest among the determination values of all the partial models.

4. The model simplification method for use in model-based development according to claim 1, wherein
the model base is an engine drive system, and the specific value is a torsion amount of the engine drive system;
a drive shaft partial model is specified as the specific partial model having the most influence on the torsion amount;
the determination values include an integral obtained by calculating torque and an angular speed for the respective partial models of the entire model base at each unit time while torque generated by an engine is gradually increased according to the engine acceleration pattern, and by integrating the absolute value of the change amount of the product of the torque and the angular speed according to the engine acceleration pattern; and
a set of the determination values that include a specific determination value of the drive shaft partial model is selected, wherein the specific determination value is the largest among the determination values of all the partial models.

5. A model simplification method for use in model-based development to determine a model base for implementation in an ECU, the method comprising:
preparing an entire model base by modeling respective parts of an entire system of the model base;
setting a plurality of integrals as determination values for each partial model, the plurality of integrals being obtained by calculating a plurality of values for each corresponding partial models at each unit time according to a predetermined engine acceleration pattern, and by integrating absolute values of change amounts of the plurality of values and an absolute value of a change amount of a product of at least two of the plurality of values according to the engine acceleration pattern;
selecting a set of the determination values as first determination values that include a first specific determination value of a first specific partial model having the most influence on a first specific value that is calculated using the model base, wherein the first specific determination value is the largest among the first determination values of all the partial models;
selecting another set of the determination values as a second determination value that include a second specific determination value of a second specific partial model having the most influence on a second specific value that is calculated using the model base, wherein the second specific determination value is the largest among the second determination values of all the partial models;
calculating a first ratio of the first determination value for each corresponding partial model to a sum of the first determination values of all the partial models, and calculating a second ratio of the second determination value for each corresponding partial model to a sum of the second determination values of all the partial models;
setting the larger one of the first ratio and the second ratio as a determination ratio for each partial model;
assigning a higher priority to a partial model that has a higher determination ratio; and
determining the model base by omitting a partial model from the complete model base in order of ascending priority until a processing load of calculating the first specific value and the second specific value is reduced to a desired value.

6. A calculation method using a model base, comprising:
reducing the processing load of calculating the specific value to or below an instantaneous processing capacity of the ECU by omitting partial models. from the model base in order of ascending priority if the instantaneous processing capacity of the ECU decreases when calculating the specific value using the model base determined by the model simplification method for use in model-based development according to claim 1 and implemented in the ECU.

7. A calculation method using a model base, comprising:
reducing the processing load of calculating the first specific value or the second specific value to or below an instantaneous processing capacity of the ECU by omitting partial models from the model base in order of ascending first ratio during the calculation of the first specific value, and by omitting a partial model from the model base in order of ascending second ratio during the calculation of the second specific value if the instantaneous processing capacity of the ECU decreases when calculating the first specific value or the second specific value using the model base determined by the model simplification method for use in model-based development according to claim 5 and implemented in the ECU.
